(19) United States
(12) Patent Application Publication
(10) Pub. No.: US 2026/0002765 A1
(43) Pub. Date: Jan. 1, 2026

(54) MULTIFUNCTIONAL RULER FOR DESIGN AND MULTI-SCALE MEASUREMENTS

(71) Applicant: Ufuk KOÇ, Istanbul (TR)

(72) Inventor: Ufuk KOÇ, Istanbul (TR)

(73) Assignee: Ufuk KOÇ, Istanbul (TR)

(21) Appl. No.: 18/879,815

(22) PCT Filed: Aug. 10, 2022
(86) PCT No.: PCT/TR2022/050839

§ 371 Date: Dec. 30, 2024

(51) Int. Cl. G01B 3/02; B43L 13/00; B43L 13/20

(52) U.S. Cl. CPC G01B 3/02; B43L 13/001; B43L 13/205

(57) ABSTRACT

The present invention relates to a rectangular multifunctional ruler which is used for measuring and design. In particular the ruler of the present invention enables the user to make measurements in different scales thus the ruler is suitable for multi-scale measurements. In addition to that, the ruler of the present invention also enables the user to sketch mathematical models or in general all kinds of shapes in order to form an unlimited number of patterns within a very short amount of time.

### FIELD OF THE INVENTION

The present invention relates to a rectangular multifunctional ruler which is used for measuring and design. In particular the ruler of the present invention enables the user to make measurements in different scales thus the ruler is suitable for multi-scale measurements. In addition to that, the ruler of the present invention also enables the user to sketch mathematical models or in general all kinds of shapes in order to form an unlimited number of patterns within a very short amount of time. This makes the ruler to be suitable for design purposes in a wide variety of technical fields, such as architecture, engineering, pattern design, logo design and the like. At the same time the ruler of the present invention serves the functions of a traditional ruler, i.e. can be used for measuring lengths, however unlike traditional rulers it can be used for measuring at different scales.

### BACKGROUND OF THE INVENTION

The first use of rulers dates back to ancient civilizations such as Greeks and Egyptians. The first excavated rulers were often made from wood or ivory. The rulers we use today are generally made from plastic, metal or wood.

A ruler is an instrument which is traditionally used to measure distances, degrees and draw straight lines. The rulers are basically used in various fields such as in engineering and architecture for technical drawings; in geometry classes at schools. Thus a ruler is almost a daily used item and is a must to have equipment for an engineer, a student and an architect. As much as it is necessary for technical drawings, a ruler is also required for certain kind of artistic drawings. Especially in the field of industrial design, logo design and/or patterns where mathematical models and/or recurring structures are incorporated into the drawing, a ruler is also crucial. Especially when considering the dynamics of the creative process, it is of utmost importance that the designer always have the possession of their drawing tools at all times so that whenever they get the inspiration for their current task, they can put it into paper, right away.

Today as well as it was in the past, the rulers serve 2 main purposes: measuring and drawing, although the aspects of measurement and drawing are much more complex and detailed in today's world. Therefore, although the traditional purpose of rulers are still the same, the same is not true anymore for types and models of rulers that are used currently all around the world. This is not surprising when the current state of the world is considered. First of all, the developments in technology caused a tremendous amount of increase in things to measure. Secondly the globalization has brought the world together however keeping the diversity of the world in place. Thus, different measurement scales still exist in today's globalized yet diversified world where an engineer used to the metric system has to do work from time to time, in the imperial system. When the second traditional purpose of rulers is considered, it gets much more complicated since the drawings that could be obtained by a ruler in today's world is not restricted with technical drawings which is getting closer and closer to art, thus making it a better choice to call it design. Therefore, in the complexity and opportunities of today's world, the design or pattern that could be obtained by a ruler should be limited by the creativity of the mind, not with the limits of the ruler used in the drawing; not to mention that the creativity of the mind is infinite.

Therefore, at various times of technological development while building today's world, different types of rulers have been developed based on the measurements needed and design necessities. Accordingly, there are several types of rulers, available in different shapes, sizes, materials which are suitable for different scales and which enable certain types of drawings. Among the available rulers in the market, the choice of the user (engineer, architect, student, designer or anybody) depends on the need of the user based on the intended purpose. For example, T square rulers are ideal for architects, engineers, and sometimes for artists.

However, with the technological development and progress, the above-mentioned increase in measurement needs and the increasing complexity of design necessities, forced an unprecedented increase in types of rulers. At one point in time, it became impractical to keep all types of rulers and select the right one for the current task. Especially when the task had to be completed at different places, this caused the engineer or designer to carry different types of rulers together with them.

There are many patent documents disclosing different types of rulers in order to meet the needs of a user.

CN203957646 discloses a geometric drawing ruler provided with various curves. The body of the geometric drawing ruler adopts a structure taking the shape of a strip-shaped plate; the two ends of the geometric drawing ruler are semicircular, and a protractor is processed at one semicircular end; one side of the geometric drawing ruler is processed into a straightedge, and another side is processed to be waved and marked with scales. The ruler is disclosed to be useful for drawing various geometric figures such as hexagonal pyramids and cylinder and it has a novel structure, reasonable design, complete functions, small size, elegant appearance, applicability and the like and is a novel geometric drawing ruler integrating economy with practicability.

TWM563968U discloses a hexagonal three-dimensional measuring ruler for drawing tables, angles or circles or concentric circles.

CN216385369 describes a multifunctional triangular ruler in order to facilitate the carrying of a drawing pen.

CN102126384 discloses a multifunctional intelligent ruler which can draw straight lines, parallel lines, vertical lines, angle lines and circles by using one ruler through a metric system scale mark (1) and an English system scale mark (2).

Each of these rulers described in the prior art patent documents have their own advantages and disadvantages.

Furthermore, the prior art rulers disclosed on the above mentioned prior art documents or present in the market, can draw limited types of geometric shapes such as a straight line or a circle. These types of prior art rulers are not suitable for multi-scale measurements, it is impossible to measure in different scales with these prior art rulers. Hence, the rulers of the prior art are not multi-functional, they are easy to damage and inconvenient to use and carry.

In summary, considering the above-mentioned prior art documents and a wide variety of rulers on the market, the idea of integrating different functions to a single ruler is not new, but there still remains a need to work in this field for incorporating as many different functions as possible without sacrificing the practicality and compactness of the ruler.

Thus, it is an object of the present invention to incorporate a wide variety measurement and drawing capabilities to a single ruler so that the users do not have to change between rulers while working on their tasks or do not have to carry many rulers when they are working out of office. It is another object of the present invention to incorporate as many as possible measurement and drawing capabilities without sacrificing the practicality and compactness of the ruler.

An engineer, a designer or a pattern maker needs a multi-functional ruler for every aspects on design which is not limited to sketching in architecture but also includes interior design, typography design, printed design, product and logo design. For a designer or a pattern maker, it is very important to begin developing the ideas by using pencil and paper. At this stage, a designer should have a ruler which is handy and user-friendly for designers.

### SUMMARY OF THE INVENTION

The present invention is specific in that it combines more features than there are currently known in the prior art. It is also characterized by its own unique compactness, convenience of use and in still being comfortable to carry and use.

The present invention analyses the following problem: different groups of people need to combine different instruments into a single tool by integrating them. This invention is ideal for children, students, and adults; is also desirable for professionals in specific fields such as engineers, builders, a designer or a pattern maker. In order to meet the needs of the market, multifunctional tools integrating several features are being developed.

Thus, the above-mentioned object of the present invention is achieved with the rectangular multifunctional ruler which combines several functions like enabling to make a measurement in different scales and drawing any shapes in seconds. The ruler has at least four different measurement scales thus distances-and much more can be measured quickly with a single ruler.

Features of the invention such as the holes or the hollow circular areas which, when drawing, clearly remain on the drawing surface, are formed at values of the ruler at certain intervals to form a certain scale and to facilitate drawing of two-dimensional structures. Furthermore, it is convenient to draw objects of astronomy, parts of the human body, buildings, plants, animals and objects wherein it is important to maintain the value of the ratio of the drawing. A level used to check the level of the plane is also incorporated.

The ruler of the present invention is suitable for carrying it in a wallet so that everybody can carry it anywhere at any time.

### BRIEF DESCRIPTION OF DRAWINGS

FIG. 1 is a front view of one of the surfaces of the preferred embodiment of the present invention.

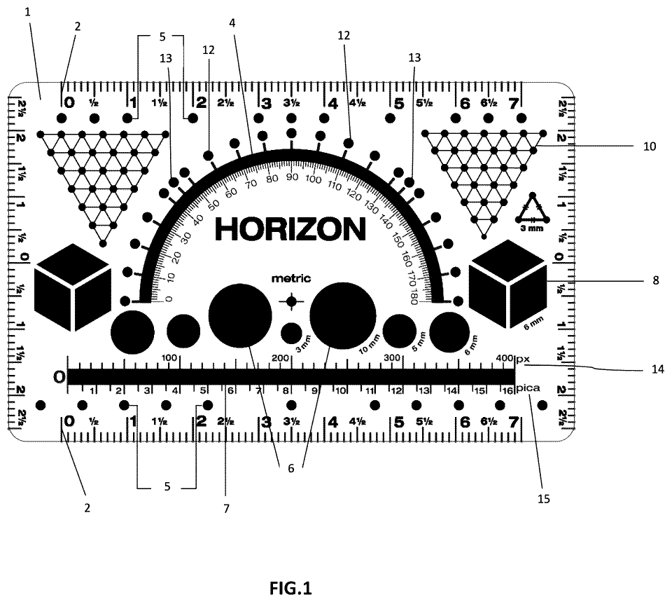

FIG. 2 is a front view of the other surface of the preferred embodiment of the present invention.

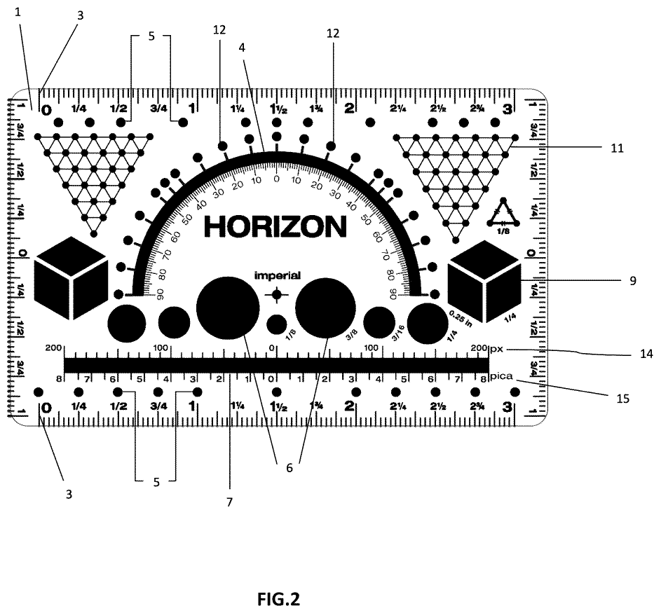

### REFERENCE NUMERALS

1 A ruler body
2 A metric system scale mark
3 An imperial system scale mark
4 An arc of 180° (marked from 0° to 180° or from 90° to 90° with intervals of 10°)
5 A plurality of holes extending through at least one of the longer sides
6 A hollow circular area
7 A metric and imperial scale line for drawing lines in different scales
8 A hollow having the shape of a projection of a cube for drawing an isometric cube (metric scale)
9 A hollow having the shape of a projection of a cube for drawing an isometric cube (imperial scale)
10 Metric scale triangular grid area (isometric grid area)
11 Imperial scale triangular grid area (isometric grid area)
12 A plurality of holes distributed above the arc
13 2 more holes distributed above the arc on the surface of which the arc is marked with 0° to 180°
14 A pixel system scale mark
15 A pica system scale mark

### DETAILED DESCRIPTION

In one embodiment, the dimensions of the rectangular multifunctional ruler is 85.60×53.98 mm. This is the internationally acknowledged size of the most of standard business cards, credit cards or ID cards. Therefore, the ruler of this preferred embodiment is compact and easy to carry around in the wallet of the user.

In another embodiment, the rectangular multifunctional ruler has more than one unit of measurement such as a metric system scale and an imperial system scale on its ruler body.

The rectangular multifunctional ruler further comprises a pixel unit. The pixel is a single point in a raster image or device. A pixel density (referred as “pixels per inch” (PPI) or “dots per inch” (DPI)) of a device varies from device to device. For some devices like printers, this value is precise. For other devices like computer displays, this value can be changed by the user. In the present invention, the PPI value has been fixed as 150 PPI.

The rectangular multifunctional ruler further comprises a pica unit of measure. A pica is a typographic unit of measure corresponding to ⅙ of inch. The pica contains 12 points.

The rectangular multifunctional ruler of the present invention further comprises a point unit of measure. A point is a typographic unit of measure corresponding to 1/72 of inch.

In one embodiment, the rectangular multifunctional ruler has a plurality of holes extending through at least one of the longer sides. A user can draw a circle with a desired size by using one of these holes thereby the need of compass is eliminated.

In one embodiment, the rectangular multifunctional ruler has a protractor for measuring up to 180 degrees. The protractor is formed by an arc of 180° on the ruler body. In the protractor part of the ruler, also plurality of holes has been distributed above the protractor for drawing arcs with different angles. The holes above the protractor part of the ruler has been distributed with an interval of 10°.

The present invention is a multifunctional rectangular ruler formed by a ruler body 1. The ruler body 1 comprises a metric system scale mark 2 on one surface, an imperial system scale mark 3 on the other surface, an arc of 180° for drawing and/or measuring arcs with different angles 4, a plurality of holes extending through at least one of the longer sides 5, at least one hollow circular area 6, and a metric and an imperial scale line 7 extending on one of the longer lines above scale marks 2, 3.

The ruler body 1 comprises at least one hollow area 8, 9 having the shape of a projection of a cube for drawing an isometric cube, and

At least one metric scale triangular grid area 10 and at least one imperial scale triangular grid area 11 comprise a plurality of holes and the distance between the holes is equal to each other.

In an embodiment of the present invention a plurality of holes 12 are distributed above the arc with an interval of 10°.

In a further embodiment the arc of 180° is marked differently on the 2 surfaces of the ruler.

In an even further embodiment the arc of 180° is marked with degrees starting from 0° to 180° on one surface and from 90° to 90° on the other surface.

In another embodiment of the present invention the arc of 180°, on the surface wherein the arc is marked with 0° to 180° comprises 2 more holes 13 distributed above the arc in such a way that the holes correspond to 45° and 135° on the arc.

In a preferred embodiment of the present invention the ruler body 1 has the dimensions of a credit card so that it is compact and easy to carry for the user.

In a different embodiment of the present invention the ruler body 1 comprises at least 4 differently dimensioned hollow circular areas 6.

In a further embodiment the ruler body 1 comprises 7 hollow circular areas wherein one of the circular areas has the diameter of 3 mm.

In a still further embodiment the ruler body comprises 7 hollow circular areas wherein a pair of 10 mm circular areas are positioned on each side of the 3 mm circular area, a pair of 5 mm circular areas are positioned adjacent to 10 mm circular areas and a pair of 6 mm circular areas are positioned adjacent to 5 mm circular areas.

In another embodiment of the present invention the ruler body 1 comprises 2 hollow areas 8, 9 having the shape of a projection of a cube for drawing an isometric cube.

In a different embodiment the ruler body comprises a pixel system scale mark 14 on both surfaces.

In a different embodiment the ruler body comprises a pica system scale mark 15 on both surfaces.

In another embodiment of the present invention the ruler body is made of stainless steel and is coated with titanium.

In a further embodiment of the present invention, the ruler body comprises an area which enables the user to draw different kinds of mathematical models starting from triangle to twenty-sided polygon (icosagon).

In a still further embodiment of the present invention, the ruler body comprises an area enabling the user to draw a hexagon grid (honeycomb pattern).

In another embodiment of the present invention the ruler body comprises an area enabling the user to draw spirograph.

In a further embodiment of the present invention the ruler body comprises an area enabling the user to quickly draw lines with thicknesses of 1 mm, 1.5 mm, 2 mm, 2.5 mm or 3 mm, in a practical way.

In a further embodiment of the present invention the ruler body comprises an area for measuring punto (points).

In a different embodiment of the present invention the ruler body comprises an area for drawing a square grid.

In different embodiments of the present invention the ruler body comprises more than 7 hollow circular areas enabling the user to draw differently dimensioned circles in a practical way.

In a further embodiment of the present invention the ruler body comprises an area enabling the user to quickly draw squares in a practical way.

In a further embodiment of the present invention the ruler body comprises an area enabling the user to draw isometric circles.

In another embodiment of the present invention the ruler body comprises a circular part comprising differently dimensioned hollow circular areas wherein the circular part is movable on a hinge on the centre such that the user can practically switch between differently dimensioned hollow circular areas to draw different circles in a practical way.

1. A multifunctional rectangular ruler formed by a ruler body (1) wherein the ruler body (1) comprises a metric system scale mark (2) on one surface, an imperial system scale mark (3) on the other surface, an arc of 180° for drawing and/or measuring arcs with different angles (4), a plurality of holes extending through at least one of the longer sides (5), at least one hollow circular area (6), a metric and an imperial scale line (7) extending on one of the longer lines above scale marks (2,3),
characterized in that the ruler body (1) comprises at least one hollow area (8, 9) having the shape of a projection of a cube for drawing an isometric cube, and
in that at least one metric and an at least one imperial scale triangular grid area (10, 11) comprising a plurality of holes and the distance between the holes is equal to each other.

2. The multifunctional ruler of claim 1 wherein a plurality of holes (12) are distributed above the arc with an interval of 10°.

3. The multifunctional ruler of claim 1 or 2 wherein the arc of 180° is marked differently on the 2 surfaces of the ruler.

4. The multifunctional ruler of claim 3 wherein the arc of 180° is marked with degrees starting from 0° to 180° on one surface and from 90° to 90° on the other surface.

5. The multifunctional ruler of claim 4 wherein the arc of 180° on the surface wherein the arc is marked with 0° to 180° comprises 2 more holes (13) distributed above the arc in such a way that the holes correspond to 45° and 135° on the arc.

6. The multifunctional ruler of anyone of preceding claims wherein the ruler body (1) has the dimensions of a credit card.

7. The multifunctional ruler of anyone of preceding claims wherein the ruler body (1) comprises at least 4 differently dimensioned hollow circular areas (6).

8. The multifunctional ruler of claim 7 wherein the ruler body (1) comprises 7 hollow circular areas wherein one of the circular areas has the diameter of 3 mm.

9. The multifunctional ruler of claim 8 wherein the ruler body comprises 7 hollow circular areas wherein a pair of circular areas having the diameter of 10 mm are positioned on each side of the circular area having the 3 mm diameter, a pair of circular areas having a diameter of 5 mm are positioned adjacent to circular areas having the diameter of 10 mm and a pair of circular areas having a diameter of 6 mm are positioned adjacent to circular areas having the diameter of 5 mm.

10. The multifunctional ruler of anyone of preceding claims wherein the ruler body (1) comprises 2 hollow areas (8, 9) having the shape of a projection of a cube for drawing an isometric cube.

11. The multifunctional ruler of anyone of preceding claims wherein the ruler body comprises a pixel system scale mark (14).

12. The multifunctional ruler of anyone of preceding claims wherein the ruler body comprises a pica system scale mark (15).

13. The multifunctional ruler of anyone of preceding claims wherein the ruler body is made from stainless steel.

14. The multifunctional ruler of anyone of preceding claims wherein the ruler body is coated with titanium.
